(19) United States
(12) Patent Application Publication
(10) Pub. No.: US 2010/0296691 A1
(43) Pub. Date: Nov. 25, 2010

(54) ELECTROMECHANICAL VIBRATION CONVERTER FOR TACTILE ACOUSTIC APPARATUS

(75) Inventor: Akira KOMATSU, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: AISHIN CO., LTD., Tokyo (JP)

(21) Appl. No.: 12/468,240

(22) Filed: May 19, 2009

(51) Int. Cl. H04R 11/02

(52) U.S. Cl. 381/413

(57) ABSTRACT

A damper 8 supports a yoke portion 16, 17 holding a magnet 18 therein. The damper 8 includes an annular yoke retainer portion 8a holding the yoke portion, a plurality of support portions 8b projecting radially outward from the yoke retainer portion 8a, a plurality of suspension spring portions 8c extending from each of the plurality of support portions 8b to an adjacent support portion along a periphery of the yoke retainer portion 8a, and a plurality of T-shaped projections 8T provided on an end of each of the plurality of suspension spring portions 8c. The plurality of T-shaped projections 8T are respectively fitted in notches K in a case so that the yoke portion 16, 17 is movable relative to the case. Because the damper 8 can be fixed to the case without any screws, the electromechanical vibration converter can readily be assembled and produced in a speaker manufacturing line.

### BACKGROUND OF THE INVENTION

This invention relates to a structure of an electromechanical vibration converter used to generate vibrotactile effects from low-frequency electric signals.

For example, in a simulation or a virtual reality, haptic senses produced by sound pressures vibrating a human body and haptic senses produced by vibration propagated on a floor or on the earth are important to improve the realism. Such vibration is referred to as vibrotactile effect. The realistic presence can be reproduced by vibrotactile effects relating to actual sounds involving vibrations or impulses, such as an explosion sound or an engine sound. Vibrotactile effects are used not only for an audio purpose to emphasize low-frequency sounds, but also for sound effects in a simulation or a virtual reality. Furthermore, vibrotactile effects are advantageously effective in various applications including musicotherapy using relaxation resulting from the vibrotactile effects, promotion of fermentation or aging of alcoholic liquors, and use for improvement in quality. As a device for generating vibrotactile effects, an electromechanical vibration converter has been used, which has a structure similar to a speaker for producing sounds.

For example, JP-B 3787777 discloses a conventional electromechanical vibration converter for generating vibrotactile effects.

As shown in FIG. 14, a conventional electromechanical vibration converter 1 generally includes a case, which includes an upper frame 2 and a lower frame 4, and a damper unit 3 housed in the case. The damper unit 3 has a magnetic circuit formed therein.

The upper frame 2 is in the form of a dish. The upper frame 2 has a circular opening 5 defined at a central portion thereof. The upper frame 2 has screw hole portions 2a, 2b, and 2c formed on a peripheral portion thereof.

The lower frame 4 is in the form of a dish having a two-stage structure. The lower frame 4 has screw hole portions 4a, 4b, and 4c formed on a peripheral portion thereof. A damper 6 is formed integrally with the lower frame 4 at a central portion of the bottom of the lower frame 4. The damper 6 includes a plurality of concentric annular members having different diameters. A lead wire 7 extends from an outer peripheral edge of the bottom of the lower frame 4. The lead wire 7 is used to transmit electric signals to a moving coil in the case.

The damper unit 3 includes annular (ring-shaped) dampers 8a and 8b having different sizes, a yoke portion 9 having a magnetic pole held inside of the annular damper 8a, and support portions 3a, 3b, and 3c (also referred to as screw hole portions 3a, 3b, and 3c) formed outside of the outer damper 8b.

The damper unit 3 is fitted in the lower frame 4. An upper portion of the damper unit 3 is covered with the upper frame 2. Those components (the upper frame 2, the damper unit 3, and the lower frame 4) are arranged so that the screw hole portions 2a, 3a, and 4a, the screw hole portions 2b, 3b, and 4b, and the screw hole portions 2c, 3c, and 4c are respectively aligned with each other. Then the components are secured by screws inserted from above the upper frame 2.

As shown in FIG. 15, the upper frame 2, the damper unit 3, and the lower frame 4 are fixed by inserting screws 11a, 11b, and 11c from above the upper frame 2 into the screw hole portions 2a-2c, 3a-3c, and 4a-4c, respectively. The opening 5 of the upper frame 2 is covered with an upper cover 5a.

As shown in FIG. 16, the yoke portion 9 located inside of the annular damper 8a is supported via the damper 8a and the damper 8b by the case.

The yoke portion 9 includes an annular top plate 17 and a bottom plate 16 having a columnar portion 15 at the center thereof. An annular magnetic pole 18 is interposed between the bottom plate 16 and the top plate 17. An annular magnetic gap 19 is formed between an inner peripheral edge of the top plate 17 and an outer circumferential surface of the columnar portion 15 on the bottom plate 16 so as to form a magnetic circuit. A cylindrical coil frame 20 extends vertically from a peripheral edge of the circular opening 5 formed at the central portion of the upper frame 2. A coil 21 is wound around a predetermined area of the coil frame 20. The area around which the coil 21 has been wound is positioned within the gap 19 when the upper frame 2 is attached to the lower frame 4.

The annular dampers include a yoke retainer portion 8a for holding the yoke portion 9 and suspension spring portions 8b disposed outside of the yoke retainer portion 8a. Each of the suspension spring portions 8b has a support portion (3a, 3b, 3c) extending radially outward. The suspension spring portions 8b are fixed to the case at the support portions. The adjacent annular dampers (i.e., the yoke retainer portion 8a and the suspension spring portions 8b) are connected to each other by a plurality of connectors. Those annular dampers (i.e., the yoke retainer portion 8a and the suspension spring portions 8b) allow the yoke portion 9 to be movable relative to the case.

A portion of the annular damper 6, which is formed at the central portion (bottom) of the lower frame 4, is held in abutment against the bottom of the bottom plate 16.

In the electromechanical vibration converter 1 having the above structure, an electric signal is transmitted via the lead wire 7 to the coil 21. Magnetic interference is produced between a magnetic force produced in the coil 21 and a magnetic force of the magnetic pole 18. The magnetic interference causes the yoke portion 9 supported via the dampers 8a and 8b by the case to move relative to the case, thereby generating vibrotactile effects.

Next, an embodiment of the annular (ring-shaped) dampers for supporting the yoke within the case will be described in detail with reference to FIG. 17.

As shown in FIG. 17, the dampers include two annular (ring-shaped) dampers 8a and 8b having different sizes. The yoke portion 9 is held inside of the inner annular damper, i.e. the yoke retainer portion 8a. The suspension spring portions 8b are arranged outside of the first damper 8a so as to surround the first damper 8a. The suspension spring portions 8b include a plurality of suspension springs (three suspension springs in this embodiment) 8b1, 8b2, and 8b3 having the same shape (arcuate shape).

The support portions 3a, 3b, and 3c (also referred to as screw hole portions) are respectively provided at end portions 26a, 26b, and 26c of the suspension springs 8b1, 8b2, and 8b3 (on outer circumferential surfaces of the suspension springs 8b1, 8b2, and 8b3). The suspension springs 8b1, 8b2, and 8b3 are fixed to the case at the screw hole portions 3a, 3b, and 3c by screws. Furthermore, connectors 25a, 25b, and 25c are provided on opposite end portions of the suspension springs 8b1, 8b2, and 8b3. The first damper 8a is connected to the suspension springs 8b1, 8b2, and 8b3 by the connectors 25a, 25b, and 25c. Those connectors 25a, 25b, and 25c are provided on the first damper 8a at equal intervals of 120 degrees. Each suspension spring extends from the connector along the circumference of the first damper 8a and reaches the support portion 3a, 3b, or 3c near the connector of the adjacent suspension spring.

Conventional Electromechanical Vibration Converter for Tactile Acoustic Apparatus

1. The particularity of an Electromechanical Vibration Converter for a Tactile Acoustic Apparatus

An electromechanical vibration converter for a tactile acoustic apparatus needs to be located within a narrow space in a seat or within a thin bed pad and also needs to avoid user's bodily discomfort. Thus, an electromechanical vibration converter is required to be as small as possible. Furthermore, many considerations should be given to the shape of an electromechanical vibration converter so that a user does not feel a solid object (discomfort) when the electromechanical vibration converter is mounted on an object on which a human body is located, such as a seat or a bed. Many attempts have continuously been made as to the structure of an electromechanical vibration converter because of the following additional concerns in addition to the above concerns.

It has not been long since an electromechanical vibration converter for a tactile acoustic apparatus was developed. Because an electromechanical vibration converter employs a magnetic circuit (a magnet and a yoke) and a moving coil as components, the closest product to an electromechanical vibration converter is a dynamic speaker. Nevertheless, the structure of an electromechanical vibration converter is considerably different from a dynamic speaker because of differences in intended use. The history of dynamic speakers is long, and many engineers are engaged in dynamic speakers. For example, a cone speaker reached the stage of perfection a long time ago, and its standard basic structure has already been completed.

On the other hand, it has not been long since an electromechanical vibration converter for a tactile acoustic apparatus was developed, and very few engineers are engaged in such an electromechanical vibration converter. The structure of the electromechanical vibration converter is still being developed, and its standard basic structure has not yet been completed. Therefore, new technical ideas or inventive elements are needed each time the design of an electromechanical vibration converter is changed. Improvements of an electromechanical vibration converter include the following aspects:

(1) Inventions of the structure of an electromechanical vibration converter for a tactile acoustic apparatus

(2) Development and modification for improvement in performance

(3) Development and modification for facilitation of production in a speaker manufacturing line through rationalization in structure, reduction of the number of parts, and facilitation of assembly (cost reduction effect)

This invention is mainly focused on the improvements (1) and (3). Particularly, the improvement (3) is given considerable weight. It is important to develop and modify the structure of an electromechanical vibration converter for a tactile acoustic apparatus such that the electromechanical vibration converter can readily be produced in a speaker manufacturing line, which will be described later.

Most of components in an electromechanical vibration converter for a tactile acoustic apparatus overlap components in a dynamic speaker. Therefore, electromechanical vibration converters for a tactile acoustic apparatus are often manufactured in a speaker factory. However, an electromechanical vibration converter is different in structure from a cone speaker. Its assembling method and manufacturing method are also different from those of a cone speaker.

Engineers of speakers, which have a long history and a standard basic structure with a high level of perfection, are likely to reject products other than speakers. Furthermore, a low level of perfection in structure of electromechanical vibration converters for a tactile acoustic apparatus is likely to increase their tendency of rejection. The difference in type of products and the low level of perfection are factors to increase cost of production and a fraction defective.

When electromechanical vibration converters for a tactile acoustic apparatus are manufactured in factories other than speaker factories, the aforementioned rejection is unlikely to occur because there are no preconceived ideas for speakers. However, those factories cannot defeat speaker manufacturers because they suffer from higher cost caused by their inexperience in procurement of materials such as magnets, yokes, moving coils, and various adhesives or by unskilled operations.

2. Assembling with an Adhesive in a Speaker Manufacturing Line

Generally, most products are assembled with screws. However, a speaker assembly line mainly employs a bonding process. A spinning lathe is often used to apply an adhesive. Therefore, structures that are assembled with screws are not suitable for production in a speaker manufacturing line.

The conventional electromechanical vibration converter for a tactile acoustic apparatus as disclosed by JP-B 3787777 is assembled with screws. (The reference numerals 2a-2c, 3a-3c, and 4a-4c in FIGS. 14-17 denote holes for screws.) Therefore, the conventional electromechanical vibration converter for a tactile acoustic apparatus is not suitable for production in a speaker manufacturing line. If the conventional electromechanical vibration converter for a tactile acoustic apparatus is manufactured in a factory other than speaker factories, the cost is disadvantageously increased as described above.

### SUMMARY OF THE INVENTION

This invention has been made in view of the above drawbacks. It is, therefore, an object of this invention to provide an electromechanical vibration converter for a tactile acoustic apparatus which can readily produced in a manufacturing line of a speaker manufacturer.

The above object is achieved by the invention as recited in claim 1.

An appreciation of the objectives of this invention and a more complete understanding of its structure may be had by studying the following description of the preferred embodiment and by referring to the accompanying drawings.

### BRIEF DESCRIPTION OF THE DRAWINGS

FIG. 1A is a front view of an electromechanical vibration converter according to an embodiment of the invention.

FIG. 1B is a side view of the electromechanical vibration converter according to the present embodiment.

FIG. 1C is a cross-sectional view taken along lines M-M shown in FIG. 1A.

FIG. 2A is a front view of the electromechanical vibration converter according to the present embodiment in a state in which an upper frame 2 has been removed.

FIG. 2B is a cross-sectional view taken along lines A-A′ shown in FIG. 2A.

FIG. 3A is a front view of a top plate 17 and a damper 8 holding the top plate 17.

FIG. 3B is a cross-sectional view taken along lines N-N shown in FIG. 3A.

FIG. 3C is a cross-sectional view taken along lines P-P shown in FIG. 3A.

FIG. 3D is an enlarged view of a suspension spring portion 8c in the damper 8.

FIG. 3E is an enlarged view of a yoke retainer portion 8a in the damper 8.

FIG. 4A is a rear view of the top plate 17 and the damper 8 holding the top plate 17 which corresponds to a state into which FIG. 3 is turned over.

FIG. 4B is an enlarged view of a support portion 8b in the damper 8.

FIG. 5 is a partial enlarged view showing another example (comparative example) of the damper.

FIG. 6 is a view explanatory of an assembling process of an entire electromechanical vibration converter according to the present embodiment.

FIG. 7 is a cross-sectional view of the electromechanical vibration converter according to the present embodiment when the entire electromechanical vibration converter is assembled.

FIG. 8 is a cross-sectional view of the electromechanical vibration converter according to the present embodiment when a face plate is to be attached to the electromechanical vibration converter.

FIG. 9 is a front view showing another example of the damper in the electromechanical vibration converter according to the present embodiment.

FIGS. 10A-10C are a front view and side views of a lower frame (case) in the electromechanical vibration converter according to the present embodiment.

FIGS. 11A and 11B are a front view and a cross-sectional view of an upper frame (coil holder) in the electromechanical vibration converter according to the present embodiment.

FIG. 12 is a front view of a modification of the electromechanical vibration converter of the present embodiment, wherein a position of a coil holder clamp mechanism is changed.

FIG. 13A is a front view of the lower frame 4.

FIG. 13B is an enlarged view of an area Y near a lead wire attachment portion and a lead wire 7.

FIG. 13C is a cross-sectional view taken along line Q-Q shown in FIG. 13B.

FIG. 13D is a cross-sectional view of the lower frame 4.

FIG. 13E is a cross-sectional view taken along line R-R shown in FIG. 13B.

FIG. 13F is a view showing a state in which the lead wire has been inserted.

FIG. 14 is an exploded perspective view showing a conventional electromechanical vibration converter.

FIG. 15 is a front view, partially in section, showing the conventional electromechanical vibration converter.

FIG. 16 is a cross-sectional view taken along lines F-F shown in FIG. 15.

FIG. 17 is a view showing dampers in the conventional electromechanical vibration converter.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of this invention as defined by the appended claims.

### DESCRIPTION OF PREFERRED EMBODIMENTS

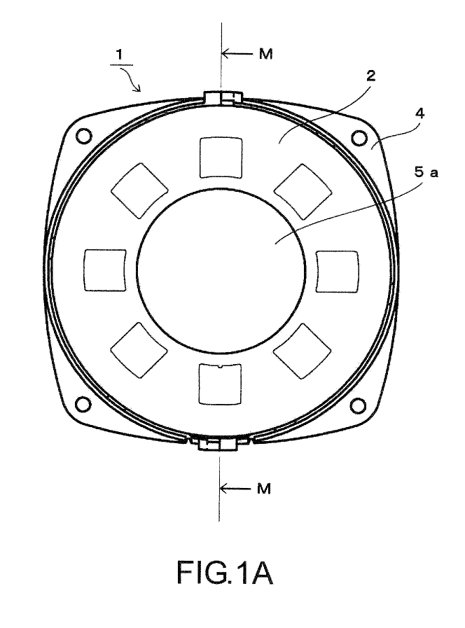

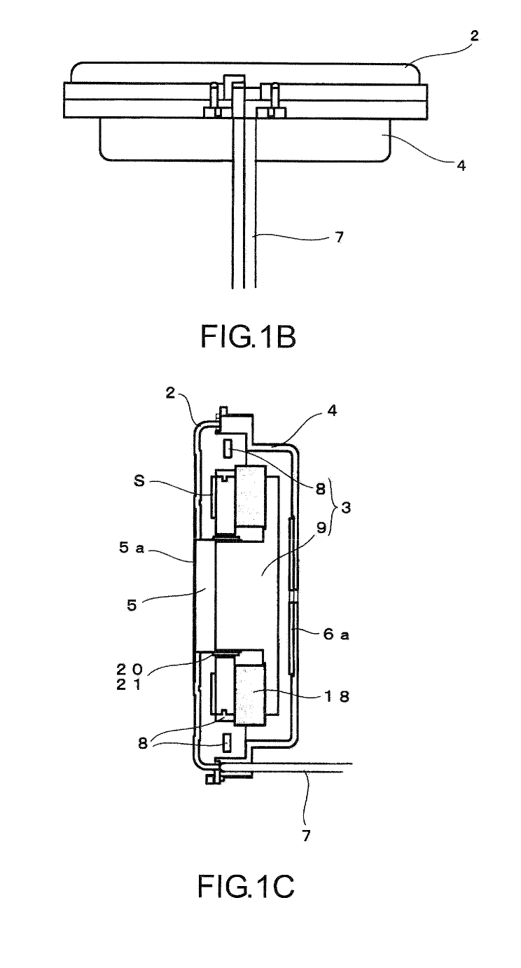

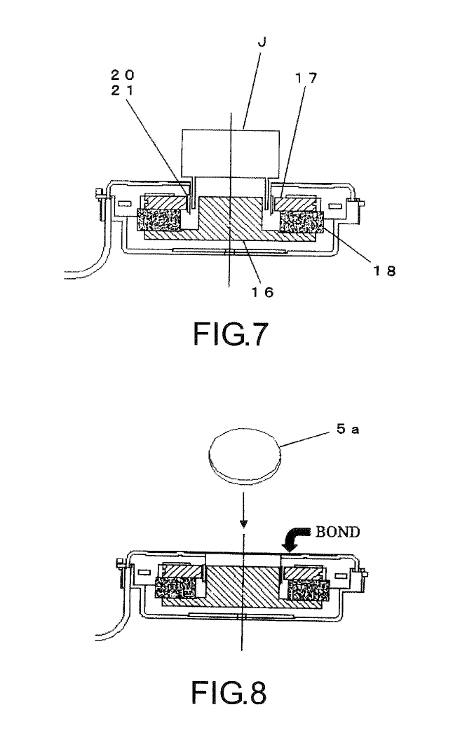

Embodiments of the invention will be described with reference to FIGS. 1A to 13F.

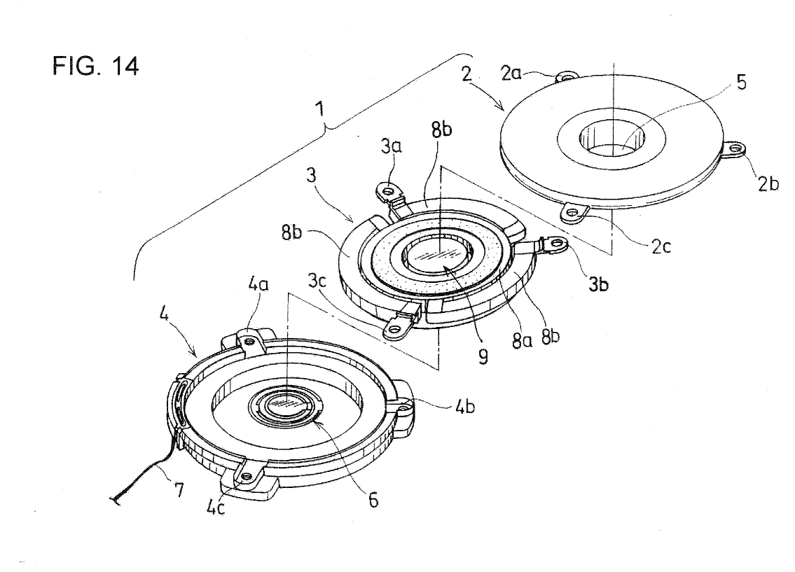

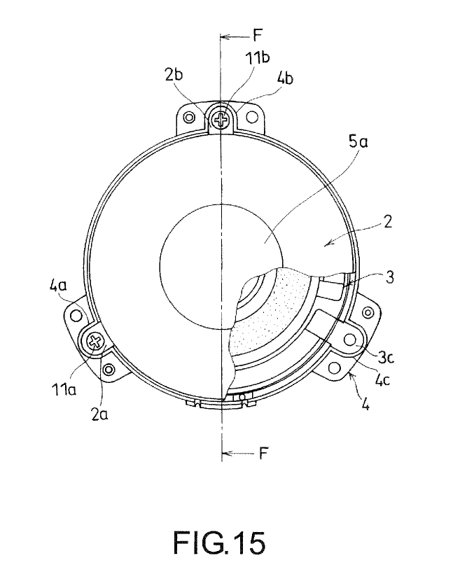

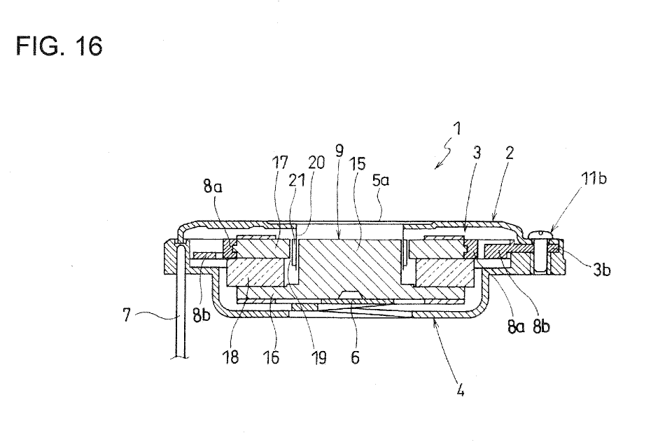

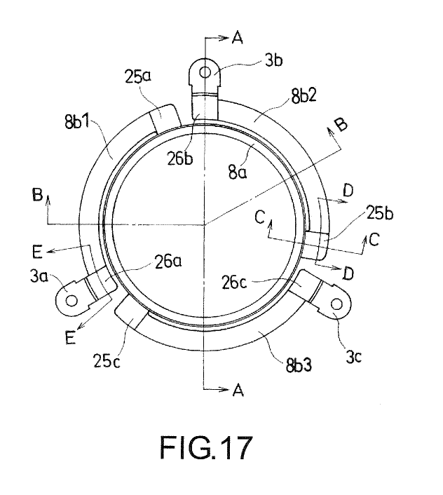

Components or parts corresponding to or equivalent to those in the conventional electromechanical vibration converter are denoted by the same reference numerals as in FIGS. 14 to 17.

An electromechanical vibration converter 1 includes a case, which includes an upper frame (coil holder assembly) 2 and a lower frame (case assembly) 4 and a magnetic circuit unit (magnetic circuit assembly) 3 housed in the case. The magnetic circuit unit 3 holds a magnetic circuit formed by a magnet 18 and a yoke portion 9.

The upper frame 2 is in the form of a dish. The upper frame 2 has a circular opening 5 defined at a central portion thereof. In a finished product, the opening 5 is covered with a face plate 5a.

The lower frame 4 is in the form of a dish having a two-stage structure. The lower stage has a smaller diameter and receives about a half of the magnetic circuit unit 3 other than a damper 8. A circular cushioning material 6a is attached to a central portion of the bottom of the lower frame 4 so as to be concentric with the lower frame 4. The cushioning material 6a has a diameter different than that of the bottom of the lower frame 4. A lead wire 7 extends from an outer peripheral edge of the lower frame 4 to transmit electric signals to a coil 21 in the case.

The magnetic circuit unit 3 includes an annular damper 8, a yoke portion 9 held inside of the annular damper 8, and a magnet 18 held by the yoke portion 9.

The magnetic circuit unit 3 is inserted and held in the lower frame 4. An upper portion of the magnetic circuit unit 3 is covered with the upper frame 2.

The damper 8 has T-shaped projections 8T. The yoke portion 9 held inside of the annular damper 8 is attached to the lower frame 4 by the T-shaped projections 8T The lower frame 4 has notches K formed in a peripheral portion thereof. The notches K are configured to receive the T-shaped projections 8T.

The yoke portion 9 includes an annular top plate 17 and a bottom plate 16 having a columnar portion 15 at the center thereof The annular magnet 18 is interposed between the bottom plate 16 and the top plate 17. An annular magnetic gap 19 is formed between an inner peripheral edge of the top plate 17 and an outer circumferential surface of the columnar portion 15 on the bottom plate 16. The bottom plate 16, the top plate 17, and the magnet 18 jointly form a magnetic circuit. A cylindrical coil frame 20 extends vertically from a peripheral edge of the circular opening 5 formed at the central portion of the upper frame 2. A coil 21 is wound around a predetermined area of the coil frame 20. The coil frame 20 and the coil 21 jointly form a moving coil. The area around which the coil 21 has been wound (the moving coil) is positioned within the gap 19 when the upper frame 2 is attached to the lower frame 4.

A cushioning material (sponge) S is placed as a cushion on the top plate 17. The cushioning material S serves to prevent collision sound produced when the electromechanical vibration converter is overswung, to reduce the impact, and to protect the electromechanical vibration converter. The cushioning material S is a doughnut-shaped sponge attached to an upper surface of the magnetic circuit unit 3 (the top plate 17).

Furthermore, a circular cushioning material (cushion) 6a is attached to the bottom of the lower frame (case) 4. A vent hole is formed in the bottom of the case. When the electromechanical vibration converter is operated, an internal temperature thereof increases, thereby expanding air within the case. The vent hole serves to release the air in the case. The vent hole also serves to allow insertion of a tool for attachment of the cushioning material and to facilitate the attachment of the cushioning material. After the doughnut-shaped upper cushioning material S has been cut out of a material, the rest of the material is used for the lower cushioning material 6a. Thus, a waste of the material is prevented, which is effective in cost reduction.

The damper 8 provides a structure in which the lower frame 4 and the yoke portion 9 are movable relative to each other.

In the electromechanical vibration converter 1 having the above structure, an electric signal is transmitted via the lead wire 7 to the coil 21. Within the gap (magnetic gap) 19, magnetic interference is produced between a magnetic force produced in the coil 21 and a magnetic force of the magnet 18. The magnetic interference causes the yoke portion 9 supported via the damper 8 by the case to move relative to the case, thereby generating vibrotactile effects. For example, the damper 8 is manufactured by resin molding. The material of the damper 8 has flexibility, and thus the damper 8 serves as a spring.

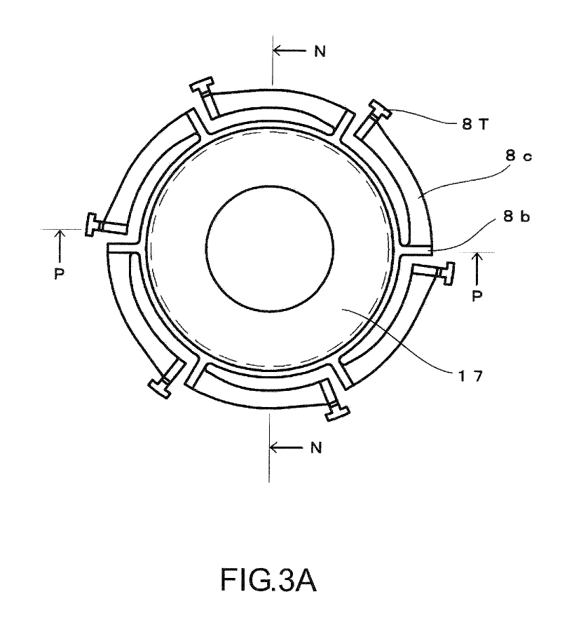

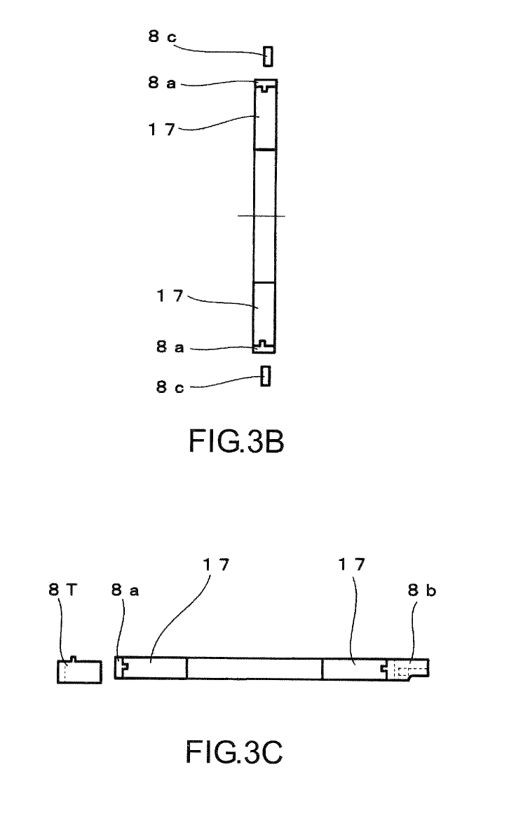

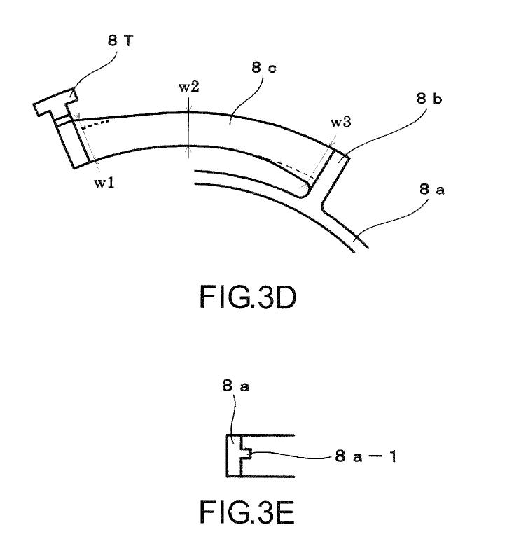

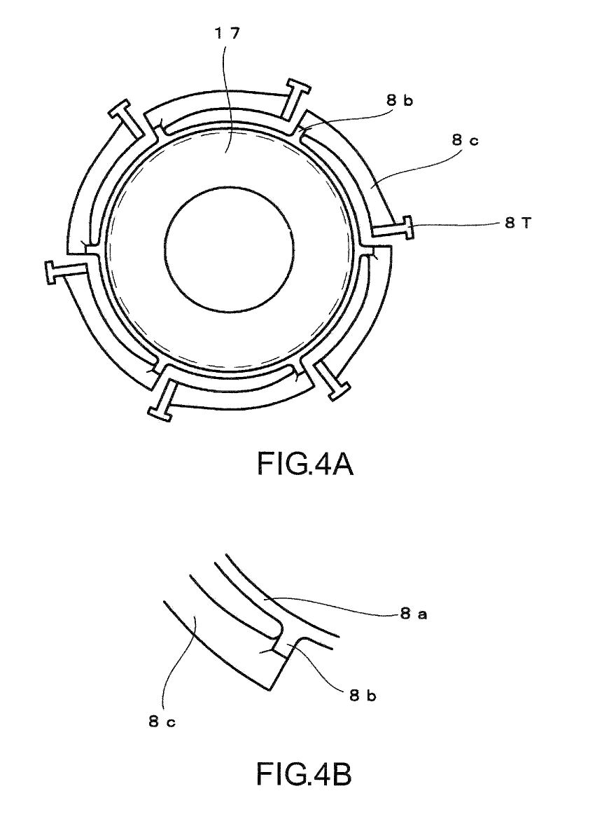

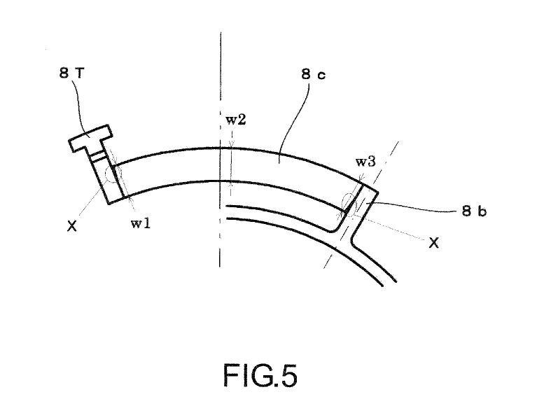

Next, an embodiment of the annular (ring-shaped) damper for supporting the yoke in the case will be described in detail with reference to FIGS. 3A to 4B.

The annular damper 8 has an annular yoke retainer portion 8a for holding the yoke portion 9, six support portions 8b projecting radially outward from the yoke retainer portion 8a, suspension spring portions 8c extending from each support portion 8b to the proximity to another support portion 8b along the periphery (circumference) of the yoke retainer portion 8a, and T-shaped projections 8T provided on an end of each suspension spring portion 8c that is opposite to the support portion 8b.

Assuming that the support portions 8b projecting from the yoke retainer portion 8a are likened to shoulders, the suspension spring portions 8c and the projections 8T correspond to arms and hands, respectively.

A protrusion 8a-1 is provided on an inner circumferential surface of the yoke retainer portion 8a. (Assuming that the yoke retainer portion 8a forms a circle, the protrusion 8a-1 is provided on a surface closer to the center of the circle.) This protrusion 8a-1 is fitted in a groove defined in an outer circumferential surface of the top plate 17, so that the yoke retainer portion 8a securely holds the top plate 17.

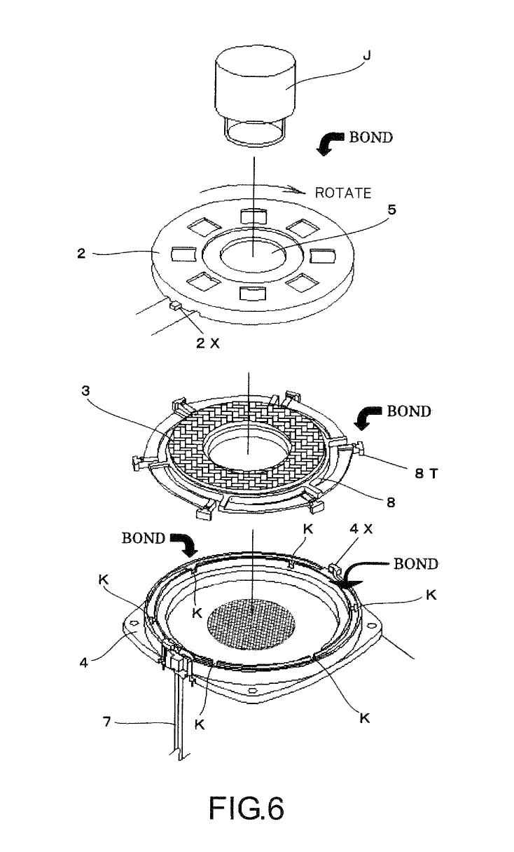

The projections 8T are fitted in the notches K formed in the lower frame 4 (see FIG. 6). In other words, the hands of the projections 8T firmly grasp the lower frame 4 with the notches K. Thus, the damper 8 and the yoke portion 9 are held on the lower frame 4. The same number of the support portions 8b, the suspension spring portions 8c, and the projections 8T are provided. In the embodiment of this invention, the number of those portions is six. The number of the support portions 8b, the suspension spring portions 8c, and the projections 8T may be two, three, four, five, seven, or more.

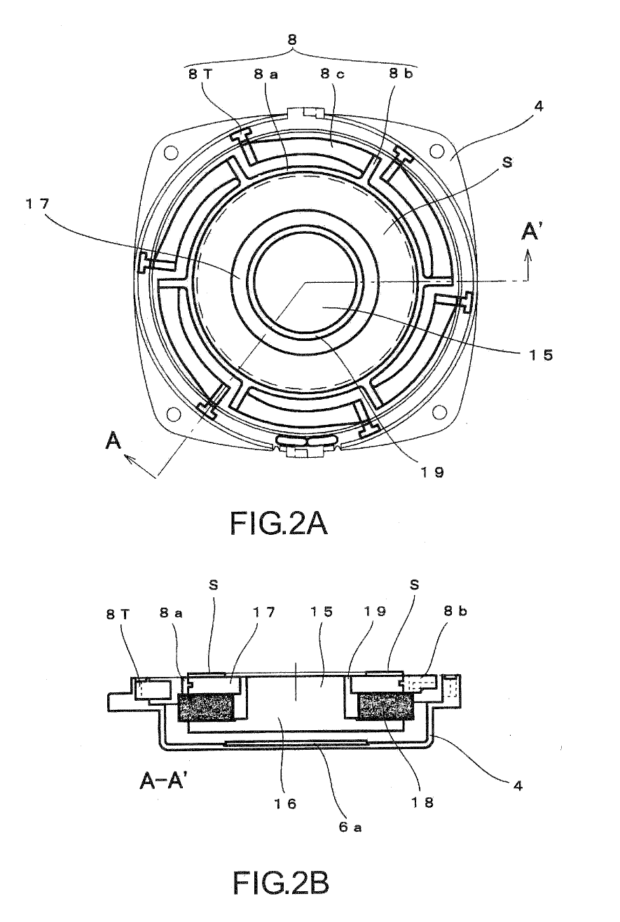

In the electromechanical vibration converter 1, as shown in FIG. 1, the moving coil 20, 21 is held at a central position of the gap (magnetic gap) 19 so as to be out of contact with the yoke portion 9 (i.e., the columnar portion 15 of the bottom plate and the top plate 17). Furthermore, the moving coil 20, 21 is held so as to be vertically movable (i.e., movable in the vertical direction of FIG. 2B). Generally, corrugated dampers are used in most of speakers. Nevertheless, the damper 8 in the electromechanical vibration converter according to the embodiment of this invention is a damper formed of plastic on the top plate 17, which is a portion of the magnetic circuit, by insert molding, as shown in the cross-sectional views of FIGS. 1C and 2B. (This is an exemplified embodiment.) The damper 8 may be formed of resin or may be die-cut of a thin plate formed of a spring material such as phosphor bronze, stainless, or spring steel.

As disclosed by Editorial staff of Fundamentals of Radios, “Hi-Fi Speaker and How to Utilize It,” Seibundo-Shinkosha, 1968, p. 38, dampers for a speaker include corrugated dampers and butterfly dampers. Nowadays, most of dampers are corrugated dampers, and butterfly dampers are rarely used. This is partially because butterfly dampers, which require an additional screw-clamping process of different nature, are not suitable for a general speaker production line, which mainly includes an assembling process with adhesive application using a spinning lathe.

The electromechanical vibration converter for a tactile acoustic apparatus according to the embodiment of this invention needs to hold the magnetic circuit unit 3, which is heavy. Therefore, a corrugated damper, which includes a cloth impregnated with phenol resin, is unsuitable in view of the capability of maintaining its center, the strength, and the miniaturization in shape. Thus, a butterfly damper is modified and customized in shape for the electromechanical vibration converter.

The shape of the suspension spring portions 8c in the damper 8 is important to hold the heavy magnetic circuit unit 3.

Unlike general speakers, the damper 8 in the electromechanical vibration converter for a tactile acoustic apparatus bears heavy loads because the suspension spring portions 8c of the damper 8 are required to suspend the heavy magnetic circuit unit 3 and the electromechanical vibration converter is required to vibrate a heavy object on which a human body is located. Therefore, the damper 8 is likely to cause problems such as breakage. For example, as shown in FIG. 5, it is assumed that the width of the suspension spring portion 8c is constant, i.e., w1=w2=w3 where w1 is the width of a position just close to the T-shaped projection 8T, w2 is the width of a position near the middle of the portion 8c, and w3 is the width of a position just close to the support portion 8b. Cracks are likely to be produced at the fixing end 8b to the magnetic circuit unit 3 which is heavy and at the fixing end 8T to the case to which a weight load is applied (or more accurately at a portion circled by X in FIG. 5), resulting in breakage.

In order to avoid this situation, according to an embodiment of this invention as shown in FIG. 3D, the width of the suspension spring portion 8c of the damper 8 is set such that w1>w2 and w3>w2.

Specifically, the shape of the suspension spring portion 8c is designed as follows.

(1) The width of the suspension spring portion 8c (the spring width) is increased at the fixing end to the heavy magnetic circuit unit 3 (at the support portion 8b) such that the suspension spring portion 8c extends (radially inward) toward the top plate 17. The dashed lines in FIG. 3d represent the suspension spring portion 8c having a constant width. The aforementioned design can be seen near the support portion 8b from the fact that the dashed line is drawn near an inner circumferential surface of the suspension spring portion 8c.

(2) The spring width is increased at the fixing end to the lower frame (case) 4 to which a weight load is applied (at the T-shaped projection 8T) such that the suspension spring portion 8c extends (radially outward) toward the case. This design can be seen near the T-shaped projection 8T in FIG. 3D from the fact that the dashed line is drawn near an outer circumferential surface of the suspension spring portion 8c.

Many experiments and attempts showed that breakage can effectively be prevented by designing the width of the suspension spring portion 8c as described in paragraphs (1) and (2). It is important (1) to increase the spring width (radially inward) toward the top plate 17 and (2) to increase the spring width (radially outward) toward the lower frame 4.

If the spring width is increased (radially outward) toward the lower frame 4 in contrast to the design (1), then the effect of breakage prevention is lessened. Additionally, since the magnetic circuit unit 3 including the top plate 17 is moved relative to the lower frame 4, an inner circumference size of the case (i.e., an inside diameter of the lower frame 4) should be increased to prevent a tip of the fixing end (i.e., the support portion 8b) from contact with the lower frame (case) 4. Therefore, miniaturization of the electromechanical vibration converter is disadvantageously inhibited.

Furthermore, if the spring width is increased (radially inward) toward the top plate 17 in contrast to the design (2), then the effect of breakage prevention is lessened. Additionally, since the magnetic circuit unit 3 is moved relative to the lower frame 4, an inside diameter of the lower frame (case) 4 should be increased to prevent a tip of the fixing end (i.e., a lower end of the T-shape of the projection 8T) from contact with the magnetic circuit unit 3. Therefore, miniaturization of the electromechanical vibration converter is disadvantageously inhibited.

Thus, the damper 8 according to the embodiment of this invention as shown in FIGS. 2A to 4B has excellent characteristics. The illustrated example is a plastic-molded damper. The aforementioned spring shape is also applicable to a die-cut damper of a thin plate formed of a spring material such as phosphor bronze, stainless, or spring steel.

Moreover, the projecting portions 8T for fixing the damper 8 to the case (i.e., the lower frame 4) produce significant effects.

According to the embodiment of this invention, each of the projecting portions (i.e., the T-shaped projections 8T) for fixing the damper 8 to the case (i.e., the lower frame 4) has a T-shape as shown in FIGS. 2A to 4B. Those projecting portions are fitted in the notches K of the lower frame 4 so as to fix the damper 8 to the case. Therefore, no screw clamp is needed.

The assembling process will be described with reference to FIG. 6. The moving coil (i.e., the coil frame 20 and the coil 21) included in the upper frame (coil holder assembly) 2 is omitted from the illustration of FIG. 6. Similarly, the bottom plate 16 (including the columnar portion 15) and the magnet 18 which are included in the magnetic circuit unit 3 are also omitted from the illustration of FIG. 6.

(a) A bond (adhesive) is applied to the six notches K of the case (i.e., the lower frame 4) and a groove formed along a peripheral portion of the case. (The bond is denoted by the reference BOND in FIG. 6.) As shown in FIG. 6, the lead wire (parallel vinyl-insulated wire) 7 is inserted in the case in advance. When an adhesive is applied to the peripheral portion of the case in this step, the adhesive is also applied to a portion of the lead wire. The lead wire 7 is pressed by the coil holder 2 and can thus be bonded and fixed with reliability. This assembling step is performed by rotating the case on a spinning lathe while applying an adhesive to a bonding portion on the peripheral portion of the case. Thus, this assembling step requires the same work as a cone speaker assembly line. Accordingly, this step facilitates production of the electromechanical vibration converter in a speaker manufacturing line.

(b) Projecting portions of the magnetic circuit unit 3, i.e., the T-shaped projections 8T of the damper 8 are aligned with the notches K. Then the magnetic circuit unit 3 is placed onto the case (i.e., the lower frame 4).

(c) A bond is applied to the projecting portions of the magnetic circuit unit 3 (i.e., the T-shaped projections 8T).

(d) A gap gauge J is inserted into the moving coil through the opening 5. The gap gauge J is inserted before the upper frame (coil holder assembly) 2 is attached to the case (i.e., the lower frame 4). The gap gauge J is a tool for maintaining a space between the moving coil 20, 21 and the yoke portion 9.

(e) The upper frame 2 is attached to the case (i.e., the lower frame 4). At that time, the upper frame 2 is rotated so that protrusions 2X provided on an outer circumferential surface of the upper frame 2 are fitted into receiving portions 4X of the case. The details of the protrusions 2X and the receiving portions 4X will be described later.

(f) Aging is conducted in a state with the gap gauge J being attached. This step is for drying and fixing the adhesive. Specifically, after completion of the above steps (a) to (e), aging is conducted in a state with the gap gauge (moving coil gauge) J being inserted until the adhesive is dried and fixed. This step is also performed in a general speaker manufacturing line.

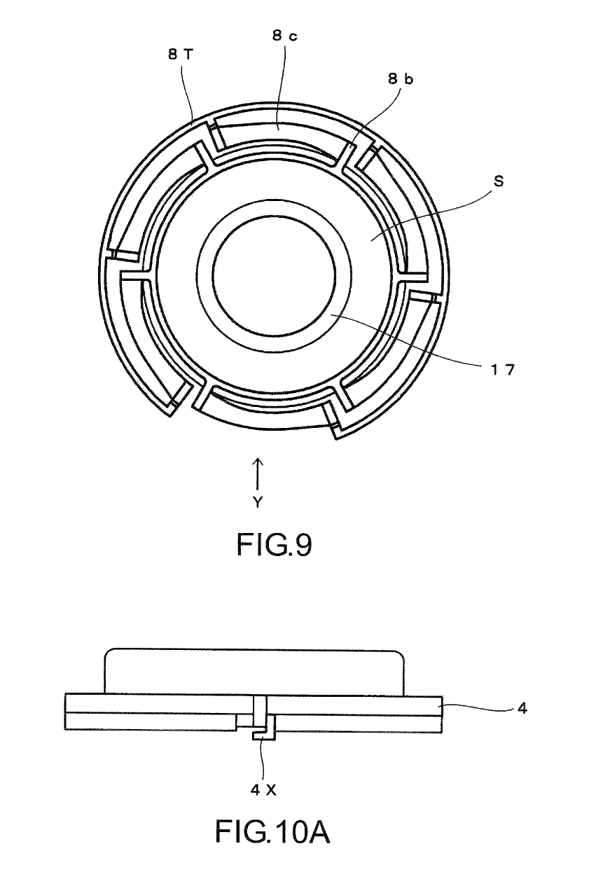

After the step (f), a face plate 5a is attached to the upper frame 2 so as to cover the opening 5 as shown in FIG. 8. Specifically, the gap gauge is removed after the aging, and the face plate (cap) 5a is attached to a central portion of the coil holder so as to cover the hole of the moving coil. This step is similar to a cap attachment process for a speaker. The face plate 5a is the same as a general aluminum face plate and includes a thin aluminum plate and an adhesive double coated tape attached on the aluminum plate. A model number, a rating, a manufacturer, and the like are printed on the face plate. Thus, the face plate not only can represent the electromechanical vibration converter but also can provide features in design.

With the assembling and bonding steps (a) to (c), the magnetic circuit unit 3 is stably held on the case (i.e., the lower frame 4) via the damper 8. Thus, the magnetic circuit unit 3 can be moved (vibrated) relative to the case via the damper 8 in a vertical direction. When the electromechanical vibration converter is vibrated, forces drawing toward the center of the case are applied to the fixing portions 8T. The fixing portions (i.e., the projections 8T) have a T-shape in order to provide support against those forces.

In the example disclosed by JP-B 3787777, a damper is fixed to a case by screws. Therefore, fixing portions (elements 2a-2c, 3a-3c, and 4a-4c in FIG. 14) project outward from the case to a large extent, thereby inhibiting miniaturization of the electromechanical vibration converter. Furthermore, an assembling process using screws is unsuitable in a speaker manufacturing line. (As described above, an assembling process with adhesive application using a spinning lathe is commonly used in a speaker manufacturing line.)

In contrast thereto, the fixing method according to the embodiment of this invention employs T-shape fitting. Accordingly, the fixing portions (i.e., the T-shaped projections 8T) can be provided within the case. (In other words, the fixing portions can be included in the bonding portions between the case and the coil holder.) Thus, this fixing method is advantageous in miniaturization of the electromechanical vibration converter. Since the fixing portions have a T-shaped end such that the top of the T-shape extends in a circumferential direction, the fixing portions do not project radially outward from the case. (For example, a Y-shaped end or a cruciform end may be used for fixing. However, those shapes are unsuitable for miniaturization because part of those shapes projects radially outward from the case. Furthermore, the Y-shaped projection may fall out due to forces drawing toward the center of the case.) Furthermore, the assembling method employs application of an adhesive with a spinning lathe as with a speaker manufacturing method. Therefore, the electromechanical vibration converter can be assembled in a speaker manufacturing line without any hindrance.

Thus, the T-shaped fitting mechanism according to the embodiment of this invention can achieve miniaturization of the electromechanical vibration converter, facilitates production of the converter in a speaker manufacturing line, and is advantageous in cost reduction.

The fixing portions shown in FIGS. 2A to 4B have a T-shape. Nevertheless, the fixing portions may have any shape other than a T-shape as long as they can provide support against forces drawing toward the center of the case. FIG. 9 shows another example of the damper. In this example, the tips of the T-shaped projections 8T are extended in a circumferential direction so that adjacent T-shaped projections 8T are connected to each other so as to form an annular shape. This example produces the same effects as the T-shaped fixing portions. A portion of the fixing portions on a lower side of FIG. 9 (a portion denoted by the reference Y) has been cut out so that the damper does not interfere with an insertion hole formed in the lower frame 4 for the lead wire 7.

In the above step (e), the upper frame 2 is attached to the case (i.e., the lower frame 4). At that time, the upper frame 2 is rotated so that the protrusions 2X provided on the outer circumferential surface of the upper frame 2 are fitted into the receiving portions 4X of the case. This step is performed to prevent bonding defects from being produced when the upper frame 2 is lifted by the lead wire 7. The coil holder clamp mechanism including the protrusions 2X and the receiving portions 4X serves as a mechanism for holding the coil holder until the adhesive is fixed. Therefore, the coil holder clamp mechanism plays an important role in improving a yield of products.

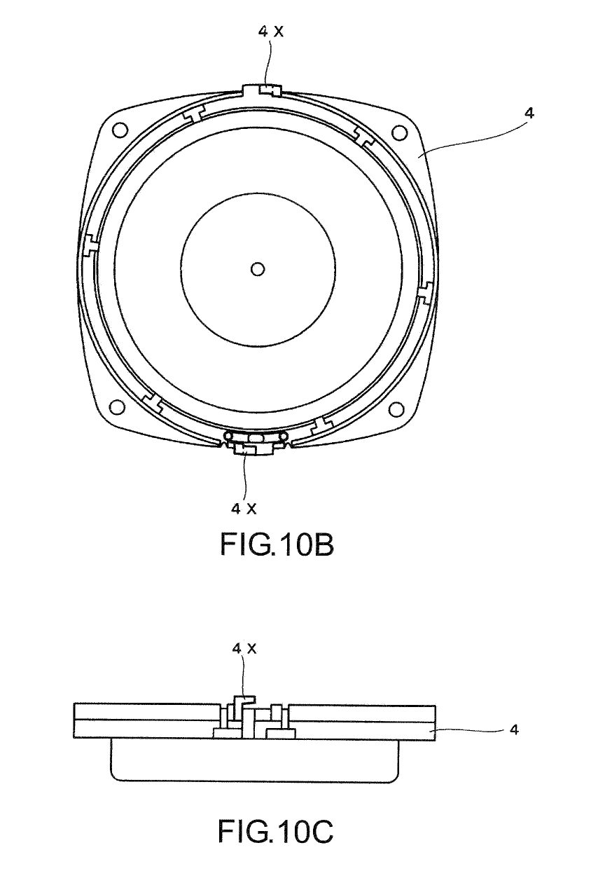

As can be seen from FIGS. 10A to 10C, two receiving portions 4X are provided and arranged at intersections of a line passing through the center of the lower frame 4 and the circumference of the lower frame 4. (In other words, the two receiving portions 4X are arranged at locations 180 degrees opposite to each other.) As shown in the side views of FIGS. 10A and 10C, each of the receiving portions 4X is in the form of a hook.

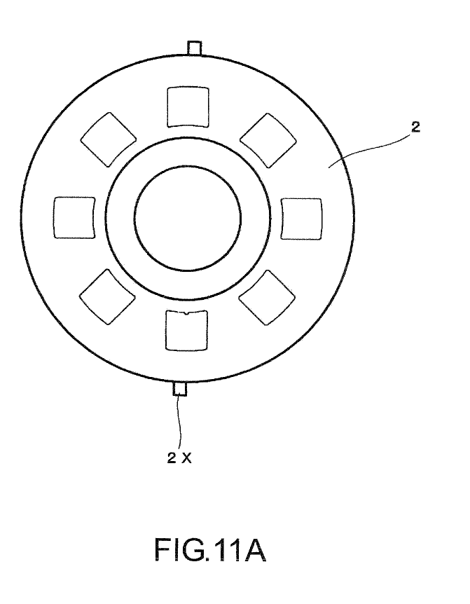

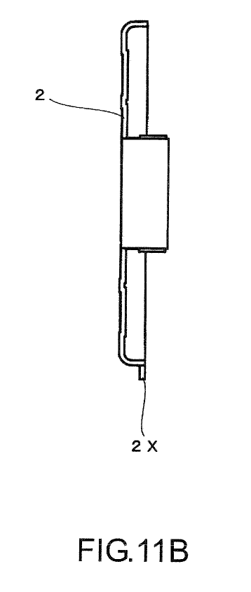

As can be seen from FIGS. 11A and 11B, two protrusions 2X are provided in the same manner as the receiving portions 4X. The two protrusions 2X are arranged at intersections of a line passing through the center of the upper frame 2 and the circumference of the upper frame 4. Each of the protrusions 2X is formed by a simple projection.

In a conventional converter, screw clamps are provided on portions equivalent to the receiving portions 4X and the protrusions 2X. Therefore, the conventional electromechanical vibration converter suffers from problems that those screw clamps are not suitable for a speaker manufacturing line and that the screw clamp mechanism enlarges the external shape of the converter. Furthermore, insert nuts for screw clamps are needed to be formed by insert molding, thereby increasing the cost of production.

The coil holder clamp mechanism (including the protrusions 2X and the receiving portions 4X) according to the present embodiment does not need insert molding for insert nuts and can reduce the cost of production. Furthermore, the coil holder clamp mechanism contributes to miniaturization of the converter because there are no large screw clamp portions projecting radially outward. The coil holder clamp mechanism can readily be adapted for a speaker manufacturing line and brings a great advantage in that there is no rejection in a speaker manufacturing line, which has been a large bottleneck in manufacturing an electromechanical vibration converter for a tactile acoustic apparatus.

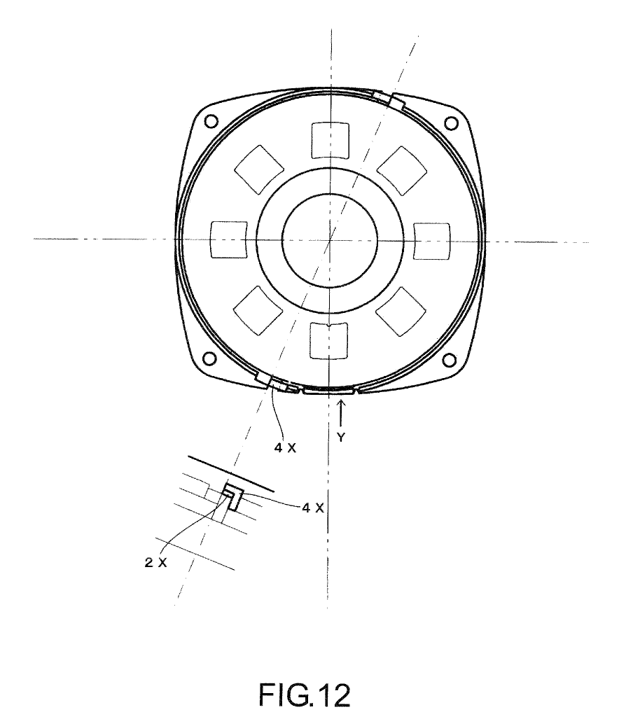

The coil holder clamp mechanism (including the protrusions 2X and the receiving portions 4X) is a mechanism for holding the upper frame 2 and the lower frame 4 close to each other. The coil holder clamp mechanism may interfere with a lead wire attachment portion and the lead wire 7 depending upon its location. FIG. 12 shows an example in which the coil holder clamp portions of the case (i.e., the receiving portions 4X) and the projecting portions of the coil holder (i.e., the protrusions 2X) are arranged at locations away from an area Y near the lead wire attachment portion and the lead wire in order to avoid such interference. This example is advantageous in that the lead wire attachment portion of the case does not require a complicated shape and that interference that would be produced to some extent can be eliminated. If one of the coil holder clamp portions (i.e., the receiving portions 4X) is arranged in the area Y near the lead wire attachment portion and the lead wire 7, the coil holder is prevented from being lifted by a pressure from the lead wire 7. Accordingly, bonding defects are prevented.

In an electromechanical vibration converter for a small-sized tactile acoustic apparatus, the above advantages can be obtained if the coil holder clamp mechanism (including the protrusions 2X and the receiving portions 4X) is arranged at a location away from the lead wire (e.g., at a side position).

Meanwhile, in a speaker that vibrates a speaker cone paper to output sounds, audio electric signals are generally inputted via terminals. In an electromechanical vibration converter for a tactile acoustic apparatus, signals may also be inputted via terminals. However, since a case of an electromechanical vibration converter is an output terminal of vibration, chattering sounds are likely to be generated at terminal portions. In a case of screw terminals, screws are likely to be loosened by the vibration. Additionally, there is a strong demand for miniaturization of an electromechanical vibration converter for a tactile acoustic apparatus in view of convenience of mounting. Provision of terminals may disadvantageously inhibit miniaturization of an electromechanical vibration converter, or their projecting portions may disadvantageously interfere with mounting of an electromechanical vibration converter.

Those findings have reveled that use of a parallel vinyl-insulated lead wire is an appropriate way to provide an input terminal of electric signals in an electromechanical vibration converter for a tactile acoustic apparatus. However, there should be a holding mechanism for establishing a stable connection between a lead wire from a moving coil, which is a portion of a thin winding of the moving coil, and a parallel vinyl-insulated lead wire for a signal input. This is particularly important to an electromechanical vibration converter for a tactile acoustic apparatus because a portion around the lead wire is also subjected to vibration. Therefore, an electromechanical vibration converter has problems that it needs some parts for such a holding mechanism and that its external shape increases.

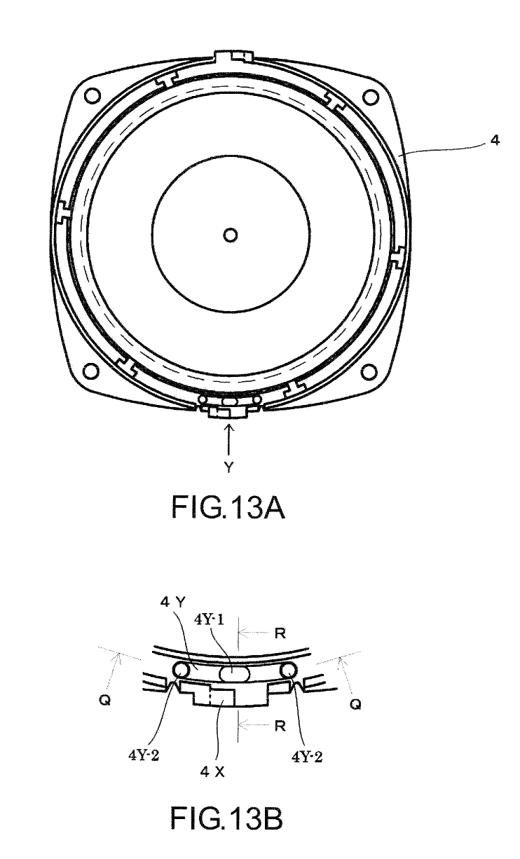

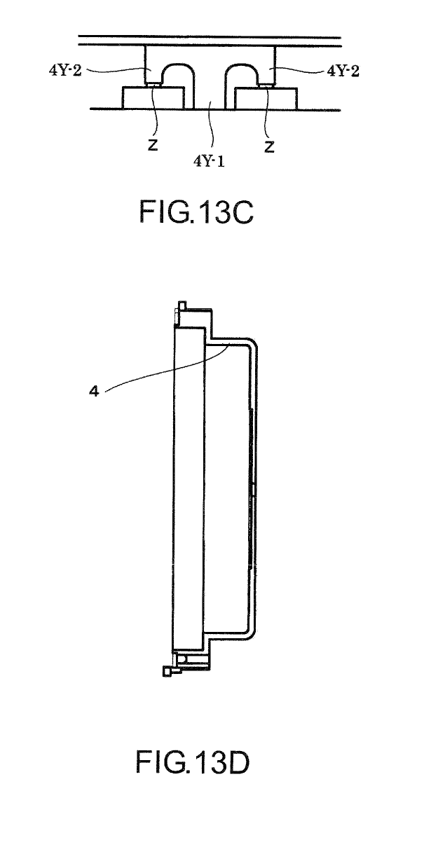

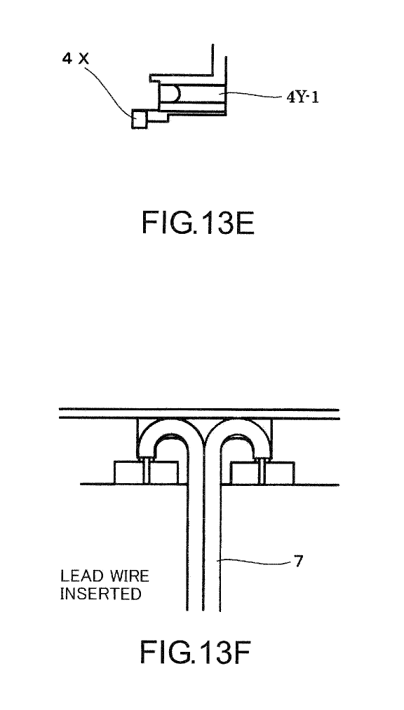

FIGS. 13A to 13F show a lead wire holding mechanism that requires no special parts and does not need to increase an exterior shape of an electromechanical vibration converter.

In FIGS. 13A to 13F, the reference 4Y denotes a hole in which a lead wire is inserted. The reference 4Y-1 denotes a through hole through which a body of the lead wire, i.e., two lines of the lead wire, passes. The reference 4Y-2 denotes a lead wire hole through which one line of the lead wire passes. A covering of the lead wire is stripped near an end (i.e., a lower end) of each hole 4Y-2, where the lead wire is soldered to a wire from the coil 21. The lead wire insertion hole 4Y roughly has a T-shape. Each of two lines of the lead wire is folded back at about 180 degrees within the lead wire insertion hole 4Y. Tips of the two lines reach an outlet of the lead wire hole 4Y-2.

In FIGS. 13A to 13F, the lead wire insertion hole 4Y is formed in part of a peripheral portion of the case (i.e., the lower frame 4). A parallel vinyl-insulated lead wire is inserted in the lead wire insertion hole 4Y as shown in FIG. 13F. Each of the holes 4Y-2 has a lower portion having a smaller diameter (as shown by the reference Z in FIG. 13C). This lower portion of the hole 4Y-2 serves as a stopper for preventing the tip of the line in the lead wire from projecting excessively and ensures insertion operation of the lead wire. When the converter is assembled in this state, the lead wire is pressed by the coil holder (i.e., the upper frame 2) and thus bonded and fixed in the converter with reliability. A lead wire of the moving coil 21 which is drawn from the coil holder is connected and soldered to the ends of the parallel vinyl-insulated wire shown in FIG. 13F.

After the soldering, an adhesive is applied to the lead wire of the moving coil and the soldered portions to fix and protect the lead wires. After application of the adhesive, aging is conducted to dry and fix the adhesive. This step is substantially the same as that in a general speaker manufacturing line and is performed in substantially the same manner. Subsequently, a finished electromechanical vibration converter is produced through a performance test and the like. This is also the same as in the case of manufacturing a speaker.

Thus, the lead wire holding mechanism according to the embodiment of this invention can hold the lead wire and establish reliable connection without any special parts or increase in size of the electromechanical vibration converter for a tactile acoustic apparatus.

An assembling process of the magnetic circuit unit 3, which is performed prior to the assembling process of the electromechanical vibration converter, will be described briefly. A bonding process including positioning the bottom plate, the magnet, and the top plate having the damper with regard to the magnetic gap by using the gap gauge is identical to a bonding process including positioning a bottom plate, a magnet, and a top plate having a frame with regard to a magnetic gap by using a gap gauge in a general speaker manufacturing line. An adhesive to be used is the same as that in a speaker manufacturing line. Accordingly, the electromechanical vibration converter can be manufactured without hindrance in a speaker manufacturing line. Since the assembling process of the magnetic circuit unit 3 does not relate directly to this invention, it will not be described in further detail.

In the foregoing description, the magnetic circuit unit 3 is an external magnetic type unit. Nevertheless, an internal magnetic type unit may be used for the magnetic circuit unit 3 as a matter of course.

According to the embodiment of this invention, an electromechanical vibration converter for a tactile acoustic apparatus can be assembled by an adhesive without any screws. Therefore, the electromechanical vibration converter can be manufactured by the same process as a process for conventional speakers. Accordingly, the electromechanical vibration converter can readily be produced in a manufacturing line of a speaker manufacturer. Thus, it is possible to improve a production efficiency and reduce a fraction defective.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. An electromechanical vibration converter for a tactile acoustic apparatus, the electromechanical vibration converter comprising:
an upper frame having a moving coil including a cylindrical coil frame formed at a central portion of the upper frame and a coil wound around the coil frame;
a magnetic circuit unit having a magnet, a yoke portion with a magnetic gap formed therein, and a damper configured to support the yoke portion, the moving coil being arranged within the magnetic gap; and
a lower frame configured to hold the magnetic circuit unit via the damper so as to allow the yoke portion to be moved relative to the upper frame in response to a current supplied to the coil,
wherein the damper includes:
an annular yoke retainer portion configured to hold the yoke portion in contact with a peripheral portion of the yoke portion,
a plurality of support portions projecting radially outward from the yoke retainer portion,
a plurality of suspension spring portions extending from each of the plurality of support portions to an adjacent support portion along a periphery of the yoke retainer portion, and
a plurality of T-shaped projections provided on an end of each of the plurality of suspension spring portions,
wherein the lower frame includes a plurality of notches configured to receive the plurality of T-shaped projections,
wherein the plurality of T-shaped projections in the damper are respectively fitted in the plurality of notches in the lower frame so that the yoke portion is movable relative to the lower frame.

2. The electromechanical vibration converter for a tactile acoustic apparatus as recited in claim 1, wherein tips of the plurality of T-shaped projections in the damper are extended in a circumferential direction of the lower frame so as to connect adjacent T-shaped projections to each other.

3. The electromechanical vibration converter for a tactile acoustic apparatus as recited in claim 1, wherein each of the plurality of suspension spring portions in the damper is widened radially inward near the support portion and radially outward near the T-shaped projection, as compared to an intermediate portion of the suspension spring portion.

4. The electromechanical vibration converter for a tactile acoustic apparatus as recited in claim 1, wherein the upper frame includes a protrusion provided on a peripheral portion thereof,
wherein the lower frame includes a receiving portion provided on a peripheral portion thereof,
wherein the protrusion Is fitted in the receiving portion when the upper frame is attached to the lower frame.

5. The electromechanical vibration converter for a tactile acoustic apparatus as recited in claim 1, wherein the lower frame includes a lead wire insertion hole formed in a peripheral portion thereof,
wherein the lead wire insertion hole includes two lead wire holes each of which allows one line of the lead wire to pass therethrough and a through hole which allows two lines in a body of the lead wire to pass theretrough,
wherein the lead wire insertion hole roughly has a T-shape as a whole,
wherein, within the lead wire insertion hole, the body of the lead wire is separated into the lines after passing through the through hole, each of the two separated lines is folded back at about 180 degrees toward the lead wire hole, and a tip of each of the two separated lines reaches an outlet of the lead wire hole.
